(19) United States
(12) Patent Application Publication
(10) Pub. No.: US 2024/0087374 A1
(43) Pub. Date: Mar. 14, 2024

(54) DETECTION APPARATUS, DETECTION METHOD, AND PROGRAM

(71) Applicant: NEC Corporation, Minato-ku, Tokyo (JP)

(72) Inventors: Yuma Yazaki, Tokyo (JP); Takahiro Kato, Tokyo (JP); Yusuke Koitabashi, Tokyo (JP)

(73) Assignee: NEC Corporation, Minato-ku, Tokyo (JP)

(21) Appl. No.: 18/274,391

(22) PCT Filed: Jan. 27, 2021
(86) PCT No.: PCT/JP2021/002771

§ 371 Date: Jul. 26, 2023

(51) Int. Cl. G07C 5/08; G07C 5/00

(52) U.S. Cl. CPC G07C 5/0808; G07C 5/008

(57) ABSTRACT

The present invention provides a detection apparatus (10) including: an acquisition unit (11) that acquires vehicle state data of each of a plurality of vehicles when each vehicle travels through a measurement position; a generation unit (12) that generates a detection model detecting an internal abnormality of a vehicle, based on the acquired vehicle state data; a detection unit (13) that performs processing of detecting an internal abnormality of a target vehicle, based on the detection model and vehicle state data when the target vehicle travels through the measurement position; and an output unit (14) that outputs a result of the detection.

### TECHNICAL FIELD

The present invention relates to a detection apparatus, a detection method, and a program.

### BACKGROUND ART

There is a technique for detecting an abnormality or the like of a vehicle by using an image photographed by a fixed-point camera or data acquired by a millimeter wave radar and other sensors. Relevant techniques are disclosed in Patent Documents 1 and 2.

Patent Document 1 discloses a technique for generating a learning model detecting an abnormal movement (dangerous driving or the like) of a vehicle, based on an image photographed by a fixed-point camera that photographs a movement of a vehicle in an intersection, and performing determination of abnormality/normality about a movement of a vehicle in an intersection, based on the learning model.

Patent Document 2 discloses a technique for generating a learning model predicting a malfunction of a vehicle, based on data of a plurality of vehicles, and predicting a malfunction of a vehicle, based on the learning model.

### RELATED DOCUMENT

### Patent Document

Patent Document 1: Japanese Patent Application Publication No. 2006-285399
Patent Document 2: International Publication No. WO 2020/110446

### DISCLOSURE OF THE INVENTION

### Technical Problem

In recent years, various types of sensors are mounted on a vehicle and various types of internal data relating to the vehicle are collected. An internal abnormality of the vehicle can be detected based on the internal data.

Incidentally, a state of internal data of a vehicle may vary according to a feature (a curve, a sharp curve, a straight line, a slope, a smooth road, a gravel road, a paved road, a narrow road, a wide road, a road with many trucks passing through, a road with many pedestrians, a road with many bicycles, a road with a tramcar running in parallel, or the like) of a position where the vehicle travels. In a case of a means for detecting an abnormality of internal data, based on, for example, a result of comparison between latest internal data and past internal data of each vehicle, a result of comparison between latest internal data of each vehicle and a reference value, or the like, without consideration of such a change according to a traveling position, an internal abnormality of a vehicle is detected with poor accuracy. Neither Patent Document 1 nor 2 discloses the problem.

The present invention addresses a problem of improving accuracy of detecting an internal abnormality of a vehicle, based on internal data of the vehicle.

### Solution to Problem

According to the present invention, provided is a detection apparatus including:
an acquisition unit that acquires vehicle state data of each of a plurality of vehicles when each vehicle travels through a measurement position;
a generation unit that generates a detection model detecting an internal abnormality of a vehicle, based on the acquired vehicle state data;
a detection unit that performs processing of detecting an internal abnormality of a target vehicle, based on the detection model and vehicle state data when the target vehicle travels through the measurement position; and
an output unit that outputs a result of the detection.

Further, according to the present invention, provided is a detection method including,
by a computer:
acquiring vehicle state data of each of a plurality of vehicles when each vehicle travels through a measurement position;
generating a detection model detecting an internal abnormality of a vehicle, based on the acquired vehicle state data;
performing processing of detecting an internal abnormality of a target vehicle, based on the detection model and vehicle state data when the target vehicle travels through the measurement position; and
outputting a result of the detection.

Further, according to the present invention, provided is a program causing a computer to function as:
an acquisition unit that acquires vehicle state data of each of a plurality of vehicles when each vehicle travels through a measurement position;
a generation unit that generates a detection model detecting an internal abnormality of a vehicle, based on the acquired vehicle state data;
a detection unit that performs processing of detecting an internal abnormality of a target vehicle, based on the detection model and vehicle state data when the target vehicle travels through the measurement position; and
an output unit that outputs a result of the detection.

### Advantageous Effects of Invention

The present invention improves accuracy of detecting an internal abnormality of a vehicle, based on internal data of the vehicle.

### BRIEF DESCRIPTION OF THE DRAWINGS

FIG. 1 is a diagram illustrating one example of a hardware configuration of a detection apparatus according to a present example embodiment.

FIG. 2 is a diagram illustrating one example of a function block diagram of the detection apparatus according to the present example embodiment.

FIG. 3 is a diagram schematically illustrating one example of information processed by the detection apparatus according to the present example embodiment.

FIG. 4 is a diagram illustrating one example of a configuration for acquiring vehicle state data by the detection apparatus according to the present example embodiment.

FIG. 5 is a diagram illustrating one example of a configuration for acquiring vehicle state data by the detection apparatus according to the present example embodiment.

FIG. 6 is a diagram illustrating one example of a configuration for acquiring vehicle state data by the detection apparatus according to the present example embodiment.

FIG. 7 is a diagram schematically illustrating one example of information processed by the detection apparatus according to the present example embodiment.

FIG. 8 is a diagram schematically illustrating one example of information processed by the detection apparatus according to the present example embodiment.

FIG. 9 is a diagram schematically illustrating one example of information processed by the detection apparatus according to the present example embodiment.

FIG. 10 is a diagram schematically illustrating one example of information processed by the detection apparatus according to the present example embodiment.

### DESCRIPTION OF EMBODIMENTS

Hereinafter, example embodiments of the present invention will be described by using the drawings. Note that, a similar component is assigned with a similar reference sign throughout all the drawings, and description therefor will be omitted as appropriate.

### First Example Embodiment

### Overview

In a present example embodiment, a measurement position is determined in a place where a vehicle travels such as a road or a parking lot. A detection apparatus acquires vehicle state data indicating a state of each of a plurality of vehicles when each vehicle travels through a measurement position. Then, the detection apparatus generates a detection model detecting an internal abnormality of a vehicle, based on the acquired vehicle state data of the plurality of vehicles. By processing vehicle state data of a plurality of vehicles when traveling through a measurement position, a general state of vehicle state data when traveling through the measurement position can be determined. A state in which vehicle state data deviate from the determined general state is detected as an internal abnormality.

“Configuration”

Next, a configuration of the detection apparatus will be described. First, one example of a hardware configuration of the detection apparatus will be described. Each function unit of the detection apparatus is achieved by any combination of hardware and software, mainly including a central processing unit (CPU) of any computer, a memory, a program to be loaded in a memory, a storage unit (in which a program downloaded from a storage medium such as a compact disc (CD), a server on the Internet, or the like can be stored as well as a program stored in advance in a stage of shipping an apparatus) such as a hard disk for storing the program, and an interface for network connection. In addition, it should be understood by a person skilled in the art that there are a variety of modified examples of a method or an apparatus for achieving the same.

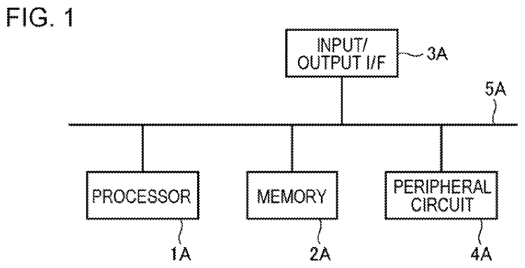

FIG. 1 is a block diagram illustrating a hardware configuration of the detection apparatus. As illustrated in FIG. 1, the detection apparatus includes a processor 1A, a memory 2A, an input/output interface 3A, a peripheral circuit 4A, and a bus 5A. The peripheral circuit 4A includes various modules. The detection apparatus may not include the peripheral circuit 4A. Note that, the detection apparatus may be configured by a plurality of physically and/or logically separated apparatuses, or may be configured by one physically and/or logically unified apparatus. When the detection apparatus is configured by a plurality of physically and/or logically separated apparatuses, each of the plurality of apparatuses can include the above hardware configuration.

The bus 5A is a data transmission path through which the processor 1A, the memory 2A, the peripheral circuit 4A, and the input/output interface 3A transmit and receive data to and from one another. The processor 1A is an arithmetic processing apparatus such as, for example, a CPU or a graphics processing unit (GPU). The memory 2A is a memory such as, for example, a random access memory (RAM) or a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can give an instruction to each module to perform an operation, based on an operation result thereof.

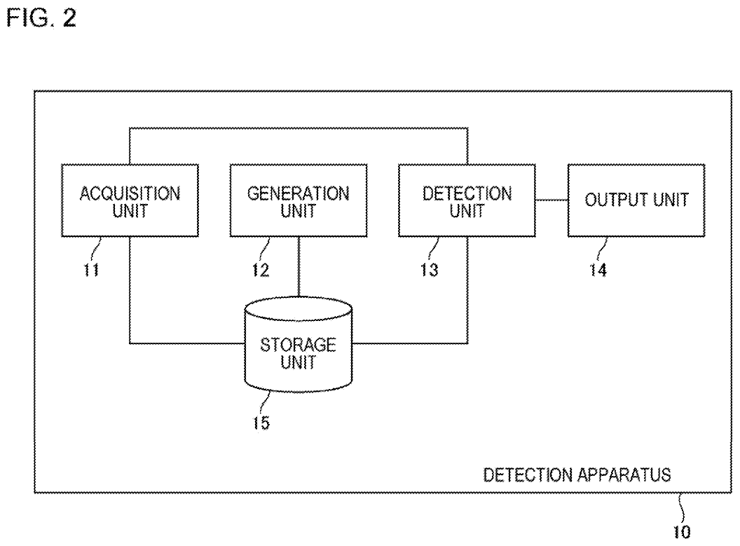

Next, a function configuration of the detection apparatus will be described. FIG. 2 illustrates one example of a function block diagram of a detection apparatus 10. As illustrated, the detection apparatus 10 includes an acquisition unit 11, a generation unit 12, a detection unit 13, an output unit 14, and a storage unit 15. Note that, the detection apparatus 10 may not include the storage unit 15. In this case, an external apparatus configured communicably with the detection apparatus 10 includes the storage unit 15.

The acquisition unit 11 acquires vehicle state data of each of a plurality of vehicles when each vehicle travels through a measurement position. The acquisition unit 11 stores the acquired vehicle state data in, for example, the storage unit 15.

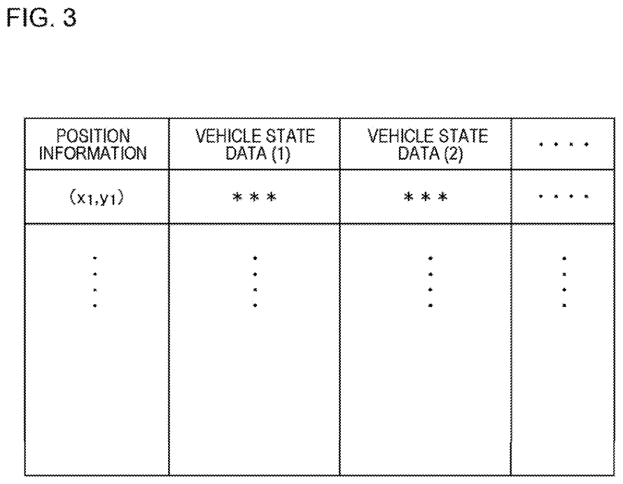

In the present example embodiment, a measurement position is determined in a place where a vehicle travels such as a road or a parking lot. One measurement position may be determined, or a plurality of measurement positions may be determined. When a plurality of measurement positions are determined, the acquisition unit 11 acquires, for each measurement position, vehicle state data of each of a plurality of vehicles when each vehicle travels through each of the measurement positions. Then, the acquired vehicle state data are stored in the storage unit 15 in association with each measurement position, as illustrated in FIG. 3. Note that, in an example illustrated in FIG. 3, latitude and longitude of a measurement position is indicated as position information indicating each measurement position, but other information may be indicated. Other examples of position information include, but not limited to, identification information assigned to each measurement position and identification information of an apparatus installed in each measurement position.

Examples of a measurement position include a ticket machine in a parking lot, a refueling machine, a railroad crossing, an electronic toll collection system (ETC) tollgate, and a stop position at an intersection. Such a measurement position is preferred for detection of an abnormality of a deceleration mechanism (a brake). Other examples of a measurement position include a right/left-turn area at an intersection and a curve. Such a measurement position is preferred for detection of an abnormality of a steering mechanism (a steering wheel or the like). Note that, measurement positions exemplified herein are merely one example and are not limited to the exemplification.

Vehicle state data are data generated by various types of processors such as an electronic control unit (ECU) or various types of sensors mounted on each vehicle. Examples of such vehicle state data include, for example, a vehicle speed, a travel distance, a travel time, an accelerator opening degree, a brake angle, a steering angle, a fuel consumption rate, a shift position, a gear/wheel speed, a diagnostic trouble code (DTC), freeze frame data (FFD), date and time of maintenance, a tire pressure, an outdoor temperature, an image acquired by photographing a vehicle interior where a passenger or a cargo is positioned, an image acquired by photographing outside of a vehicle in such a way as to include another vehicle, a pedestrian, or a sign, a result of analyzing the images, and a result of sensing by LIDER or radar. Examples of a result of analyzing an image or a result of sensing by LIDER or radar include the number of passengers, a state (a face or a line of sight) of a passenger, a cargo volume, a state of a cargo, a type (a vehicle/a pedestrian/a sign/a white line or the like) of a target detected outside a vehicle, a position of a target, a distance to a target, and text information (a number plate/a guide sign).

“Vehicle state data when traveling through a measurement position” are data sensed when traveling through a measurement position (that may include a periphery thereof), a photographed image, or a result of analyzing the data or the image.

The vehicle state data acquired by the acquisition unit 11 may further include user identification information. The user identification information may be stored in advance in an on-vehicle apparatus or the like. The user identification information is information mutually identifying users of a service provided by the detection apparatus 10.

Next, a specific example of a means for acquiring vehicle state data of each vehicle by the acquisition unit 11 will be described.

### First Acquisition Example

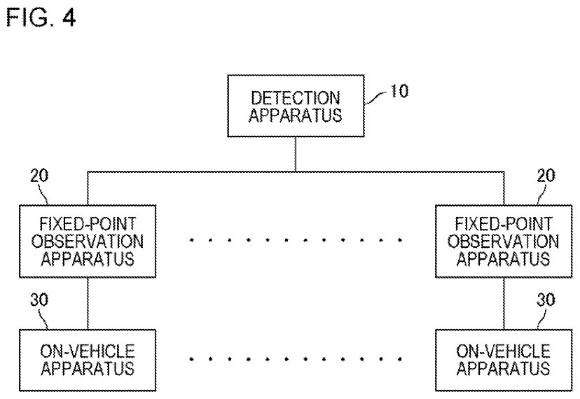

A configuration of a first acquisition example is illustrated in FIG. 4. In the acquisition example, the detection apparatus 10, a fixed-point observation apparatus 20, and an on-vehicle apparatus 30 cooperate with one another. The fixed-point observation apparatus 20 is an apparatus installed at each measurement position. The on-vehicle apparatus 30 is an apparatus mounted on each vehicle. The fixed-point observation apparatus 20 and the on-vehicle apparatus 30 are configured communicably with each other through road-to-vehicle communication.

The fixed-point observation apparatus 20 communicates with the on-vehicle apparatus traveling through a measurement position where the own apparatus is installed, and receives, from the on-vehicle apparatus 30, vehicle state data when traveling through the measurement position. Then, the fixed-point observation apparatus 20 transmits, to the detection apparatus 10, the vehicle state data received from the on-vehicle apparatus 30. The data transmission from the fixed-point observation apparatus 20 to the detection apparatus 10 may be performed by real-time processing, or may be performed by batch processing (transmission in a batch at every predetermined time (example: every 15 minutes, every hour, every 24 hours)).

As a modified example, the fixed-point observation apparatus 20 and the processing apparatus 10 may be configured into a unified apparatus. In a case of the modified example, the processing apparatus 10 unified with the fixed-point observation apparatus 20 is installed at every measurement position. Then, each processing apparatus 10 communicates with the on-vehicle apparatus 30 traveling through each measurement position, and receives, from the on-vehicle apparatus 30, vehicle state data when traveling through the measurement position. Then, each processing apparatus 10 processes the vehicle state data acquired at each measurement position, and performs generation of a detection model and detection of an internal abnormality of a vehicle.

### Second Acquisition Example

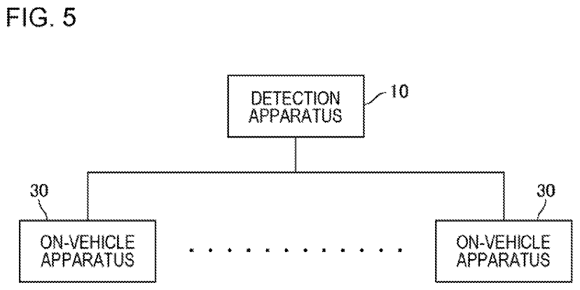

A configuration of a second acquisition example is illustrated in FIG. 5. In the acquisition example, the detection apparatus 10 and the on-vehicle apparatus 30 cooperate with each other. The on-vehicle apparatus 30 is an apparatus mounted on each vehicle. The detection apparatus 10 and the on-vehicle apparatus 30 are configured communicably with each other via a communication network such as the Internet.

The on-vehicle apparatus 30 stores position information (latitude and longitude information) of a measurement position in advance. Then, the on-vehicle apparatus 30 collates current position information (global positioning system (GPS) information or the like) of the own apparatus with the position information of the measurement position by real-time processing, and monitors whether a current position of the own apparatus is the measurement position. Then, when detecting that a current position of the own apparatus is the measurement position, the on-vehicle apparatus 30 associates the position information at the time with vehicle state data when traveling through the measurement position, and transmits the vehicle state data to the detection apparatus 10. The transmission of vehicle state data from the on-vehicle apparatus 30 to the detection apparatus 10 may be performed by real-time processing, or may be performed by batch processing (transmission in a batch at every predetermined time (example: every 15 minutes, every hour, every 24 hours)).

Note that, as a modified example of the acquisition example, the on-vehicle apparatus may perform the above collation by batch processing. In the modified example, the on-vehicle apparatus 30 accumulates vehicle state data in association with a traveling position at the time. Then, the on-vehicle apparatus 30 processes accumulated information by batch processing, and carries out detection of a fact that a current position of the own apparatus is a measurement position or transmission of vehicle state data to the detection apparatus 10.

### Third Acquisition Example

A configuration of a third acquisition example is illustrated in FIG. 5. In the acquisition example, the detection apparatus 10 and the on-vehicle apparatus 30 cooperate with each other. The on-vehicle apparatus 30 is an apparatus mounted on each vehicle. The detection apparatus and the on-vehicle apparatus 30 are configured communicably with each other via a communication network such as the Internet.

The on-vehicle apparatus 30 transmits current position information (GPS information or the like) of the own apparatus to the detection apparatus 10. The detection apparatus 10 collates position information (latitude and longitude information) of a measurement position with the received current position information, and monitors whether a current position of the on-vehicle apparatus 30 is the measurement position. Then, when detecting that a current position of the on-vehicle apparatus 30 is the measurement position, the detection apparatus 10 requests, to the on-vehicle apparatus 30, vehicle state data when traveling through the measurement position. In response to the request, the on-vehicle apparatus 30 transmits, to the detection apparatus 10, vehicle state data when traveling through the measurement position.

Note that, the transmission of current position information from the on-vehicle apparatus 30 to the detection apparatus 10, the request of vehicle state data from the detection apparatus 10 to the on-vehicle apparatus 30, and the transmission of vehicle state data from the on-vehicle apparatus 30 to the detection apparatus 10 may be performed by real-time processing, or may be performed by batch processing.

Further, as a modified example of the acquisition example, the on-vehicle apparatus 30 may transmit, to the detection apparatus 10, all pieces of vehicle state data in association with a traveling position. Then, the detection apparatus 10 may extract, from among the pieces of received vehicle state data, vehicle state data when traveling through a measurement position.

### Fourth Acquisition Example

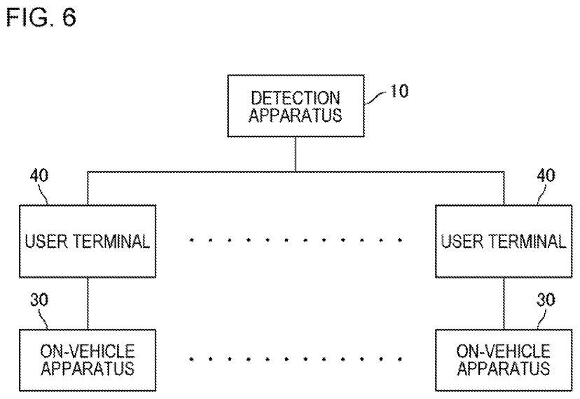

A configuration of a fourth acquisition example is illustrated in FIG. 6. In the acquisition example, the detection apparatus 10, the on-vehicle apparatus 30, and a user terminal 40 cooperate with one another. The on-vehicle apparatus 30 is an apparatus mounted on each vehicle. The user terminal 40 is a terminal possessed by a user, and examples thereof include, but not limited to, for example, a smartphone, a tablet terminal, a smartwatch, a mobile phone, and a handheld game console. The detection apparatus 10 and the user terminal 40 are configured communicably with each other via a communication network such as the Internet. The on-vehicle apparatus 30 and the user terminal 40 are configured communicably with each other by near-field wireless communication, wired communication via a cable, or the like.

The acquisition example is different from the second and third acquisition examples in a point that the detection apparatus 10 and the on-vehicle apparatus 30 communicate with each other via the user terminal 40. Other configurations are similar to the second and third acquisition examples.

Note that, as a modified example of the fourth acquisition example, at least part (acquisition of current position information, collation with a measurement position, request of vehicle state data, or the like) of processing performed by any of the detection apparatus 10 and the on-vehicle apparatus 30 described in the second and third acquisition examples may be performed by the user terminal 40.

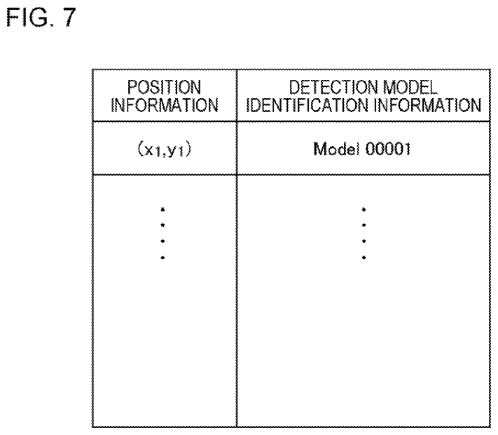

Returning to FIG. 2, the generation unit 12 generates a detection model detecting an internal abnormality of a vehicle, based on (for example, by statistically processing) vehicle state data acquired by the acquisition unit 11. The generation unit 12 stores the generated detection model in, for example, the storage unit 15. When the acquisition unit 11 acquires vehicle state data for each of a plurality of measurement positions, the generation unit 12 processes vehicle state data of each measurement position for each measurement position, and generates the above detection model for each measurement position. Then, the generation unit 12 stores each detection model in, for example, the storage unit 15 in association with a measurement position, as illustrated in FIG. 7.

By processing vehicle state data of a plurality of vehicles when traveling through each measurement position, a general state (a value, a range of a numerical value, a tendency in time-series change, an inter-data relationship, or the like) of vehicle state data when traveling through each measurement position can be determined. The above detection model is a model detecting a state in which vehicle state data deviate from the determined general state as an internal abnormality. The above detection model is generated by, for example, machine-learning vehicle state data acquired by the acquisition unit 11 as learning data. Further, the above detection model may be generated by, for example, statistically processing vehicle state data acquired by the acquisition unit 11. The detection model may be expressed by any form including an equation, a conditional expression, a table, or a combination thereof.

Returning to FIG. 2, the detection unit 13 performs processing of detecting an internal abnormality of a target vehicle, based on a detection model generated by the generation unit 12 and vehicle state data when the target vehicle travels through a measurement position. Note that, when a detection model is generated for each of a plurality of measurement positions, the detection unit 13 performs processing of detecting an internal abnormality of a target vehicle, based on a detection model associated with a measurement position through which the target vehicle travels.

The output unit 14 outputs a result of detection. Specifically, the output unit 14 notifies a user of a result of detection. The output unit 14 may notify a user of all results of detection regardless of a content thereof, or may notify a user that an internal abnormality is detected only when detected. Hereinafter, examples of a means for notifying a user will be indicated.

### First Notification Example

A configuration of a first notification example is illustrated in FIG. 4. In the notification example, the detection apparatus 10, the fixed-point observation apparatus 20, and the on-vehicle apparatus 30 cooperate with one another. The fixed-point observation apparatus 20 is an apparatus installed at each measurement position. The on-vehicle apparatus 30 is an apparatus mounted on each vehicle. The fixed-point observation apparatus 20 and the on-vehicle apparatus 30 are configured communicably with each other through road-to-vehicle communication.

The detection apparatus 10 transmits a result of detection to the on-vehicle apparatus 30 via the fixed-point observation apparatus 20. The on-vehicle apparatus 30 outputs the received result of detection via an output apparatus such as a display or a speaker.

For example, a result of detection based on vehicle state data acquired from the on-vehicle apparatus 30 of a target vehicle via the fixed-point observation apparatus 20 installed at a first measurement position is transmitted to the on-vehicle apparatus 30 of the target vehicle via the fixed-point observation apparatus 20 installed at another measurement position. Examples of a means for identifying the target vehicle at the another measurement position include, but not limited to, a means for collating user identification information included in vehicle state data received from the on-vehicle apparatus 30 of the target vehicle at the first measurement position and the another measurement position and a means for collating a number (information described on a number plate) of the target vehicle determined by analyzing an image of the target vehicle photographed at the first measurement position and the another measurement position.

### Second Notification Example

In the notification example, the output unit 14 can notify a user of a result of detection by using transmission of an electronic mail, provision of information on a webpage or a page of an application, a push notification function of an application, or the like.

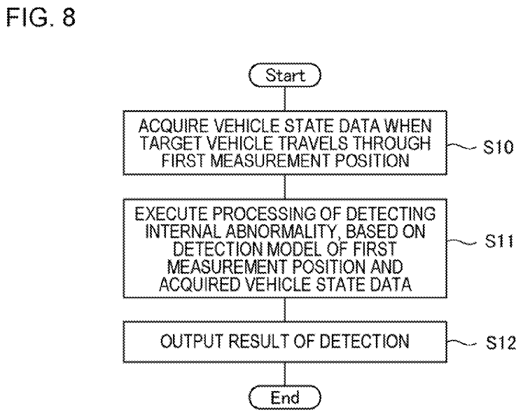

Next, one example of a flow of processing of detecting an internal abnormality of a target vehicle will be described by using a flowchart in FIG. 8. Before processing in FIG. 8 is executed, processing of acquiring vehicle state data of each of a plurality of vehicles when each vehicle travels through a measurement position and generating a detection model detecting an internal abnormality of a vehicle, based on the acquired vehicle state data is executed.

When acquiring vehicle state data when a target vehicle travels through a first measurement position (S10), the detection apparatus 10 executes processing of detecting an internal abnormality of the target vehicle, based on a detection model generated in advance in association with the first measurement position and the vehicle state data acquired in S10 (S11). Then, the detection apparatus 10 outputs a result of the detection (S12).

### Advantageous Effect

A state of internal data of a vehicle may vary according to a feature (a curve, a sharp curve, a straight line, a slope, a smooth road, a gravel road, a paved road, a narrow road, a wide road, a road with many trucks passing through, a road with many pedestrians, a road with many bicycles, a road with a tramcar running in parallel, or the like) of a position where the vehicle travels. In a case of a means for detecting an abnormality of internal data, based on, for example, a result of comparison between latest internal data and past internal data of each vehicle, a result of comparison between latest internal data of each vehicle and a reference value, or the like, without consideration of such a change according to a traveling position, an internal abnormality of a vehicle is detected with poor accuracy.

The present example embodiment acquires, for each measurement position, vehicle state data of each of a plurality of vehicles when each vehicle travels through each measurement position, and generates a detection model detecting an internal abnormality of a vehicle, based on the vehicle state data. By processing vehicle state data of a plurality of vehicles when traveling through each measurement position, a general state of vehicle state data when traveling through each measurement position can be determined. A state in which vehicle state data deviate from the determined general state is detected as an internal abnormality.

The detection apparatus 10 according to the present example embodiment as described above improves accuracy of detecting an internal abnormality of a vehicle.

### Second Example Embodiment

In a present example embodiment, a detection apparatus 10 divides vehicles into groups, based on attribute data of the vehicle. Then, the detection apparatus 10 generates a detection model being generated for each measurement position, further for each group. Hereinafter, description will be given in detail.

An acquisition unit 11 acquires vehicle information data indicating a vehicle type, a model year, a model, a vehicle classification (four-wheeled/two-wheeled or the like), and the like of a vehicle.

The acquisition unit 11 may achieve acquisition of vehicle information data by using a means similar to acquisition of vehicle state data described in the first example embodiment. In this case, vehicle information data are stored in advance in an on-vehicle apparatus 30.

Besides the above, a user may perform processing of registering vehicle information data in advance. Then, vehicle information data may be stored in, for example, a storage unit in association with user identification information of each user. In this case, when extracting user identification information included in vehicle state data received from the on-vehicle apparatus 30, the acquisition unit 11 reads out vehicle information data associated with the user identification information from, for example, the storage unit 15.

A generation unit 12 divides vehicles into groups, based on vehicle attribute data, and generates a detection model for each group.

Vehicle attribute data include the above vehicle information data. Besides the above, vehicle attribute data may include a vehicle interior state determined based on vehicle state data, and the vehicle interior state is the number of passengers, a cargo volume, or the like.

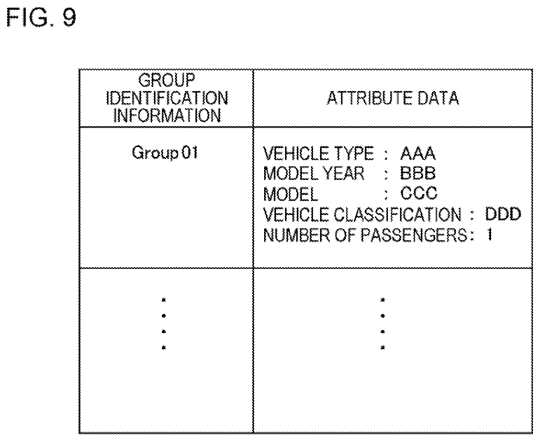

The generation unit 12 divides vehicles into groups by gathering vehicles having vehicle attribute data matching or similar to each other. A value for attribute data of each group is defined in advance, as illustrated in FIG. 9. The generation unit 12 divides a plurality of vehicles into groups, based on the definition.

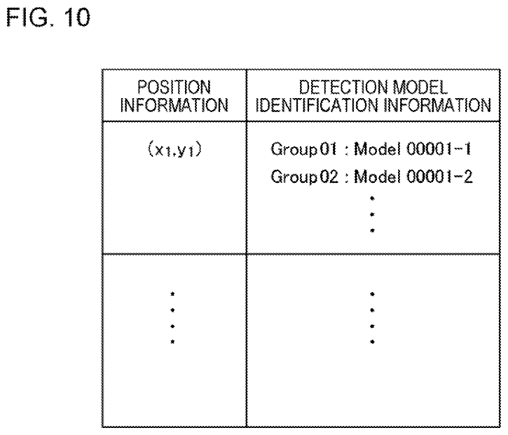

Then, the generation unit 12 generates, for each group, a detection model, based on vehicle state data of a vehicle belonging to each group. Consequently, a detection model is generated for each measurement position and for each group, as illustrated in FIG. 10.

A detection unit 13 performs processing of detecting an internal abnormality of a target vehicle by using a detection model associated with a group to which the target vehicle belongs.

Other configurations of the detection apparatus 10 are similar to the first example embodiment.

As described above, the detection apparatus 10 according to the present example embodiment can achieve an advantageous effect similar to the first example embodiment.

A state of internal data of a vehicle when traveling through each measurement position may vary according to a vehicle type, a model year, a model, a vehicle classification (four-wheeled/two-wheeled or the like), a vehicle interior state, and the like of the vehicle. The detection apparatus 10 according to the present example embodiment that divides vehicles into groups by gathering vehicles having the attributes matching or similar to each other, processes vehicle state data for each measurement position and for each group of vehicles, and generates a detection model detecting an internal abnormality of a vehicle further improves accuracy of detecting an internal abnormality of a vehicle.

### Third Example Embodiment

In a present example embodiment, when an internal abnormality of a target vehicle is detected, a detection apparatus 10 determines a type of the internal abnormality, and notifies a user. Hereinafter, description will be given in detail.

When an internal abnormality of a target vehicle is detected based on a detection model and vehicle state data when the target vehicle travels through a measurement position, a detection unit 13 determines a type of the internal abnormality of the vehicle. As illustrated in a following table 1, association information in which a detected internal abnormality and a type of the internal abnormality are associated with each other is generated in advance, and is stored in, for example, a storage unit 15. The detection unit 13 determines a type of an internal abnormality, based on the association information.

TABLE 1

| Detected internal abnormality | Type of internal abnormality |
|---|---|
| Divergence in correlation between | Malfunction of transmission: |
| vehicle speed and engine rotation | Possibility of clutch wear |
| speed in comparison with same | |
| vehicle type | |
| Brake warning lamp is lit | Malfunction of brake system: |
| | Possibility of traveling with parking |
| | brake operated |
| Vehicle speed or gear/wheel speed | Malfunction of engine system: |
| rotation speed fluctuates violently | Possibility of occurrence of hunting |
| and malfunction DTC of air-intake | due to air-intake system fault |
| system is detected | |
| Distance between vehicle and | Malfunction of camera/sensor system: |
| vehicle ahead fluctuates violently | Possibility of dirt or fault of |
| | camera/sensor |
| . | . |
| . | . |
| . | . |

An output unit 14 further notifies a user of a type of a determined internal abnormality. The output unit 14 can output a concession indicating a type of an internal abnormality by using a means similar to output of a result of detection described in the first example embodiment.

Other configurations of the detection apparatus 10 are similar to the first and second example embodiments.

As described above, the detection apparatus 10 according to the present example embodiment can achieve an advantageous effect similar to the first and second example embodiments.

Further, the detection apparatus 10 according to the present example embodiment enables a user to recognize a content (a type) of an internal abnormality occurring in a vehicle in more detail. Consequently, the user can easily recognize a measure or the like to be taken for the internal abnormality.

### Fourth Example Embodiment

In a present example embodiment, a detection apparatus 10 detects an internal abnormality of a target vehicle by integrating results of detection at a plurality of measurement positions. Hereinafter, description will be given in detail.

A detection unit 13 performs detection of an internal abnormality of a target vehicle, based on each piece of vehicle state data when the target vehicle travels through each of a plurality of measurement positions. Then, the detection unit 13 associates a result of detection in each time with predetermined identification information (user identification information, a number (information described on a number plate) of a vehicle determined by an image analysis, or the like), and stores the result in, for example, a storage unit 15. Then, the detection unit 13 detects an internal abnormality of a target vehicle by integrating results of a plurality of times of detection.

For example, when an identical internal abnormality is detected a plurality of times in a certain target vehicle, the detection unit 13 may determine that the internal abnormality is occurring in the target vehicle. Then, an output unit 14 may notify a user that the internal abnormality is occurring.

Other configurations of the detection apparatus 10 are similar to the first to third example embodiments.

As described above, the detection apparatus 10 according to the present example embodiment can achieve an advantageous effect similar to the first to third example embodiments.

Further, the detection apparatus 10 according to the present example embodiment can detect an internal abnormality of a target vehicle by integrating results of a plurality of times of detection. Consequently, accuracy of detection is further improved.

### Modified Example

In the first to fourth example embodiments, an internal abnormality of a target vehicle is detected based on vehicle state data when the target vehicle travels through a measurement position. As a modified example, an internal abnormality of a target vehicle may be detected based on vehicle state data when the target vehicle is stopping at a measurement position.

For example, the detection unit 13 may detect continuation of idling for a predetermined period of time or more as an internal abnormality, based on vehicle state data of a target vehicle. In this case, the output unit 14 notifies a user of a possibility of occurrence of battery death.

While the example embodiments of the present invention have been described with reference to the drawings, the example embodiments are illustrative of the present invention, and various configurations other than the above can be employed.

Note that, “acquisition” in the present description includes at least one of “fetching (active acquisition), by an own apparatus, data stored in another apparatus or storage medium”, based on a user input or based on an instruction of a program, for example, requesting or inquiring another apparatus to receive data, accessing another apparatus or storage medium to read out data therefrom, or the like, and “inputting (passive acquisition), to an own apparatus, data output from another apparatus”, based on a user input or based on an instruction of a program, for example, receiving delivered (transmitted, push-notified, or the like) data, selectively acquiring received data or information, and “acquiring new data generated by editing data (such as conversion to a text, sorting of data, extraction of some data, or change of a file format) or the like”.

The whole or part of the above-described example embodiments can be described as, but not limited to, the following supplementary notes.

1. A detection apparatus including:
an acquisition unit that acquires vehicle state data of each of a plurality of vehicles when each vehicle travels through a measurement position;
a generation unit that generates a detection model detecting an internal abnormality of a vehicle, based on the acquired vehicle state data;
a detection unit that performs processing of detecting an internal abnormality of a target vehicle, based on the detection model and vehicle state data when the target vehicle travels through the measurement position; and
an output unit that outputs a result of the detection.

2. The detection apparatus according to supplementary note 1, wherein
the acquisition unit acquires, for each of a plurality of the measurement positions, vehicle state data of each of a plurality of vehicles when each vehicle travels through each of the measurement positions, and
the generation unit generates the detection model for each of the measurement positions.

3. The detection apparatus according to supplementary note 1 or 2, wherein
the output unit notifies a user of a detection result when an internal abnormality is detected.

4. The detection apparatus according to any one of supplementary notes 1 to 3, wherein
the generation unit divides vehicles into groups, based on vehicle attribute data, and generates the detection model for each group.

5. The detection apparatus according to supplementary note 4, wherein the vehicle attribute data include at least one of a vehicle type, a model year, a model, a vehicle classification, and a vehicle interior state.

6. The detection apparatus according to any one of supplementary notes 1 to 5, wherein
the detection unit determines a type of an internal abnormality of a vehicle.

7. The detection apparatus according to any one of supplementary notes 1 to 6, wherein
the detection unit performs detection of an internal abnormality of the target vehicle, based on each piece of vehicle state data when the target vehicle travels through each of a plurality of the measurement positions, and detects an internal abnormality of the target vehicle by integrating results of a plurality of times of the detection.

8. The detection apparatus according to any one of supplementary notes 1 to 7, wherein
the acquisition unit acquires vehicle state data acquired by a fixed-point observation apparatus installed at the measurement position from a vehicle traveling through the measurement position through road-to-vehicle communication.

9. A detection method including,
by a computer:
acquiring vehicle state data of each of a plurality of vehicles when each vehicle travels through a measurement position;
generating a detection model detecting an internal abnormality of a vehicle, based on the acquired vehicle state data;
performing processing of detecting an internal abnormality of a target vehicle, based on the detection model and vehicle state data when the target vehicle travels through the measurement position; and
outputting a result of the detection.

10. A program causing a computer to function as:
an acquisition unit that acquires vehicle state data of each of a plurality of vehicles when each vehicle travels through a measurement position;
a generation unit that generates a detection model detecting an internal abnormality of a vehicle, based on the acquired vehicle state data;
a detection unit that performs processing of detecting an internal abnormality of a target vehicle, based on the detection model and vehicle state data when the target vehicle travels through the measurement position; and
an output unit that outputs a result of the detection.

### REFERENCE SIGNS LIST

10 On-vehicle apparatus
11 Acquisition unit
12 Generation unit
13 Detection unit
14 Output unit
15 Storage unit
1A Processor
2A Memory
3A Input/output I/F
4A Peripheral circuit
5A Bus

What is claimed is:

1. A detection apparatus comprising:
at least one memory configured to store one or more instructions; and
at least one processor configured to execute the one or more instructions to:
acquire vehicle state data of a vehicle at the time of traveling through a measurement position;
generate a detection model detecting an internal abnormality of a vehicle, based on the acquired vehicle state data of a plurality of vehicles;
detect an internal abnormality of a target vehicle, based on the detection model and vehicle state data of the target vehicle at the time of traveling through the measurement position; and
output a result of the detection.

2. The detection apparatus according to claim 1, wherein the processor is further configured to execute the one or more instructions to:
acquire, for each of a plurality of the measurement positions, vehicle state data of each of a plurality of vehicles at the time of traveling through each of the measurement positions, and
generate the detection model for each of the measurement positions.

3. The detection apparatus according to claim 1, wherein
the processor is further configured to execute the one or more instructions to notify a user of the result of detection in a case that an internal abnormality is detected.

4. The detection apparatus according to claim 1, wherein
the processor is further configured to execute the one or more instructions to divide vehicles into groups, based on vehicle attribute data, and generates the detection model for each group.

5. The detection apparatus according to claim 4, wherein
the vehicle attribute data include at least one of a vehicle type, a model year, a model, a vehicle classification, and a vehicle interior state.

6. The detection apparatus according to claim 1, wherein
the processor is further configured to execute the one or more instructions to determine a type of an internal abnormality of a vehicle.

7. The detection apparatus according to claim 1, wherein
the processor is further configured to execute the one or more instructions to detect an internal abnormality of the target vehicle, based on each piece of vehicle state data of the target vehicle at the time of traveling through each of a plurality of the measurement positions, and detects generate an integrated internal abnormality of the target vehicle by integrating results of a plurality of times of the detection.

8. The detection apparatus according to claim 1, wherein
the processor is further configured to execute the one or more instructions to acquire vehicle state data acquired by a fixed-point observation apparatus installed at the measurement position, the fixed-point apparatus configured to acquire the vehicle state data from the vehicle traveling through the measurement position through road-to-vehicle communication.

9. A detection method comprising,
by a computer:
acquiring vehicle state data of a vehicle at the time of traveling through a measurement position;
generating a detection model detecting an internal abnormality of a vehicle, based on the acquired vehicle state data of a plurality of vehicles;
detecting an internal abnormality of a target vehicle, based on the detection model and vehicle state data of the target vehicle at the time of traveling through the measurement position; and
outputting a result of the detection.

10. A non-transitory storage medium storing a program causing a computer to:
acquire vehicle state data of a vehicle at the time of traveling through a measurement position;
generate a detection model detecting an internal abnormality of a vehicle, based on the acquired vehicle state data of a plurality of vehicles;
detect an internal abnormality of a target vehicle, based on the detection model and vehicle state data of the target vehicle at the time of traveling through the measurement position; and
output a result of the detection.
